(19) United States
(12) Patent Application Publication
(10) Pub. No.: US 2007/0205369 A1
(43) Pub. Date: Sep. 6, 2007

(54) Scintillator with improved light collection

(75) Inventors: Scott T. Huth, Macedonia, OH (US); William F. Harder, Uniontown, OH (US)

Correspondence Address: LOWRIE, LANDO & ANASTASI, LLP;S1432, 1 MAIN ST., SUITE 1100, CAMBRIDGE, MA, 02142, US

(73) Assignee: Saint-Gobain Ceramics & Plastics, Inc., Worcester, MA (US)

(21) Appl. No.: 11/711,942

(22) Filed: Feb. 28, 2007

Related U.S. Application Data
(60) Provisional application No. 60/779,024, filed on Mar. 3, 2006.

(51) Int. Cl. G01T 1/20

(52) U.S. Cl. 250/368

(57) ABSTRACT

The light collection efficiency of plastic scintillators used to detect low energy γ-ray radiation is improved by utilizing diffuse reflective materials instead of specular reflective materials.

### CROSS-REFERENCE TO RELATED APPLICATION

This application claims the benefit of U.S. Provisional Application Ser. No. 60/779,024 entitled “SCINTILLATOR WITH IMPROVED LIGHT COLLECTION,” filed Mar. 3, 2006, which is herein incorporated by reference in its entirety.

### BACKGROUND OF THE INVENTION

1. Field of the Invention

The present invention is directed to scintillation systems and, more particularly, to scintillation systems comprising an organic scintillator with a diffuse reflective material.

2. Discussion of Related Art

Scintillation systems detect radiation that is typically not readily detected by conventional photodetectors by utilizing a fluorescent component. The scintillating material, or scintillator, absorbs radiation, the excitatory radiation, and, in response, the scintillator emits a scintillation light that is more conveniently detectable. For example, scintillation systems can be used to detect radiation, such as gamma rays, by absorbing the excitatory radiation, and emitting ultraviolet light, infrared light, or even visible light.

Plastic scintillators, typically comprised of a polymeric matrix having fluorescent solutes, can advantageously be used where a variety of shapes or sizes are desirable. Plastic scintillators typically have high absorption characteristics with respect to electrons and fast neutrons but have low γ-ray detection efficiency.

### SUMMARY OF INVENTION

Scintillation-based apparatus of the invention can be utilized in many applications including, for example, as charged particle detectors, neutron detectors, densitometers, level indicators, as well as portal monitors and waste monitors.

In accordance with one or more embodiments, the invention provides a radiation detection apparatus comprising an organic scintillator and a diffusive reflective material disposed on at least a portion of a surface of the organic scintillator.

In accordance with further embodiments, the invention provides a method of fabricating a radiation detector comprising enclosing at least a portion of an organic scintillator with at least one diffusive reflective material.

Some embodiments of the invention are directed to a method of providing a radiation detection apparatus.

Other embodiments of the invention are directed to a method of characterizing a radiation emission. The method can comprise one or more acts of providing a radiation detection apparatus comprising an organic scintillator, having a diffuse reflective material on at least a portion of at least one surface thereof, and at least one photomultiplier assembly operatively coupled to the organic scintillator.

### BRIEF DESCRIPTION OF THE DRAWINGS

The accompanying drawings are not intended to be drawn to scale. In the drawings, each identical or nearly identical component that is illustrated is represented by a like numeral. For purposes of clarity, not every component may be labeled. In the drawings:

FIG. 1 is an illustration of a scintillation component of a detector apparatus in accordance with one or more aspects of the invention; and

FIG. 2 is a graph showing the reflectivity of a scintillation component of a detector in accordance with one or more aspects of the invention as well as the reflectivity of a scintillation component having a conventional configuration.

### DETAILED DESCRIPTION OF THE INVENTION

One or more aspects of the invention are directed to improving the efficiency of radiation detector systems. Other aspects of the invention are directed to improving the count performance in low energy radiation detection applications, especially in low energy γ-ray detection or monitoring applications. Further aspects of the invention are directed to components in radiation apparatus that reduce losses from scintillation components. Aspects of the invention can be directed to increasing the light collection characteristics of scintillation materials. In accordance with some embodiments, the invention can provide systems and techniques for detecting or monitoring low energy radiation, such as but not limited to, low energy gamma-ray radiation. In some systems and techniques of the invention, the light yield of scintillation materials is increased providing improved light collection efficiency.

In typical detector devices, scintillation light or scintillation photons are created in a scintillation component comprising at least one material, the scintillation material, capable of providing a response to ionization energy, e.g., excitatory radiation. Detector devices of the invention typically further include one or more components that provide an electronic representation of the response. Examples of components that detect or can be used to monitor and provide an electronic representation of the response include, but are not limited to photomultiplier tube (PMT) systems or assemblies, available from, for example, Hamamatsu Photonics K.K., Hamamatsu City, Japan.

The representation or signal can be provided to one or more output devices, such as a display or monitor, and/or transmitted to one or more receiving facilities. Thus, for example, the detector devices or systems can provide information about a radiation emission locally and/or to a remotely located installation. Transmission can be effected by wireless signals and/or through a network such as an intranet and/or the Internet.

One or more embodiments pertinent to one or more of these aspects are directed to scintillation materials optically coupled to materials having improved reflective phenomena. Indeed, in accordance with some embodiments of the invention, conventional, low scintillation efficiency materials can be modified to have improved response to low energy γ-ray radiation, such as those with less than about 100 keV. Thus, for example, one or more embodiments of the invention can involve detector systems utilizing one or more organic scintillators, e.g., scintillation materials comprising one or more fluorescent compounds in a polymeric matrix, having a light returning casing. Particular embodiments of the invention can be directed to organic scintillators that are at least partially surrounded by the casing.

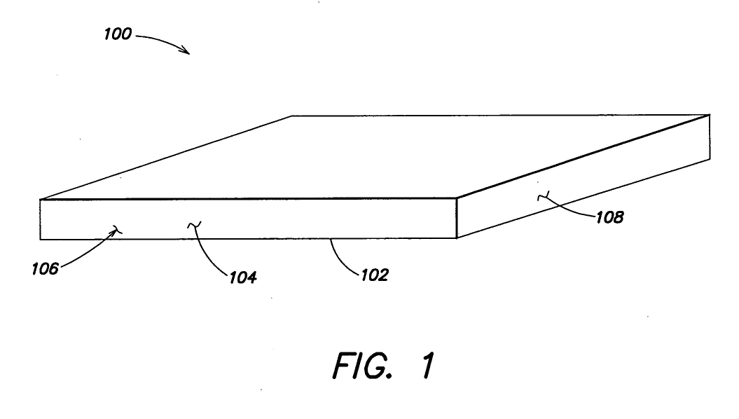

As exemplarily illustrated in FIG. 1, one or more embodiments of the invention can be directed to a scintillator or scintillation component 100 comprising one or more fluorescent species disposed in a carrier or matrix. The one or more fluorescent species can be advantageously selected to provide desirable characteristics responsive to excitation energy incident thereon. The scintillator can thus be an organic scintillator comprising at least one fluor in a polymeric matrix. Component 100 can further comprise a reflective material 102, preferably disposed on at least one surface 104 of the polymeric material body 106. Preferably, reflective material 102 at least partially encapsulates component 100. Typically, at least a portion the scintillator is optically exposed such that component 100 can be optically coupled to one or more PMT devices (not shown). For example, reflective material 102 can wrap all surfaces of component 100 except for surface 108, which can then be optically coupled to a PMT assembly, directly or through an optical conduit (not shown).

Organic scintillators of the invention can be composed of aromatic hydrocarbons with fluorescent compounds in a polymeric matrix. The organic scintillators of the invention can be comprised of low Z-elements that typically interact based on Compton scattering and/or photoelectric effect. Because organic scintillators typically have a low density, they are relatively larger, compared to inorganic scintillators, so as to provide acceptable detection efficiency. Because organic scintillators typically have low intrinsic scintillation efficiency, the responses to X-rays or γ-rays below about 100 keV can be less than the light output of, for example, a NaI(Tl) inorganic scintillator by a factor of four times.

The polymeric matrix typically has aromatic rings. Examples of such polymeric materials include, but are not limited to, polystyrene or polyvinylbenzene and polyvinyltoluene or polymethylstyrene, as well as mixtures or blends and/or analogs thereof. The organic scintillators typically include at least one fluorescent compound, or fluor, that can effect a wavelength shift of the excitatory energy to light having a convenient, or readily detectable wavelength. The fluors are preferably stable, chemically inert, especially in the polymeric matrix, radiation resistant, and exhibit an efficient and fast response. Non-limiting examples of wavelength shifters include secondary fluors such as p-terphenyl, DPO, PBD and other oxadiazole analogs and variants, and tertiary fluors such as 1,4-bis(4-methyl-5-phenyloxazolyl)benzene (POPOP), TBP, BBO, and DPS. Organic scintillators are commercially available from, for example, Saint-Gobain Ceramics & Plastics, Inc., Newbury, Ohio.

The reflective materials of the invention can also direct, provide, and/or return scintillation light or scintillation photons to one or more PMT devices. The reflective materials of the invention can utilize diffusive reflection phenomena to direct at least a portion of scintillation light to be detected, monitored, or otherwise quantified to at least one detector such as a PMT device. The diffuse reflectors of the invention can be characterized as having an uneven or granular surface such that scintillation light incident on a surface thereof is reflected at a plurality of angles. Diffuse reflection contrasts with specular reflection which is mirror-like reflection such that incident light from one direction is reflected to a single direction. Because reflective surfaces, however, can exhibit a continuum of modes of reflection between specular and diffuse, the invention contemplates a range of diffusive reflective character. Thus, some embodiments of the invention can involve reflective materials that at least partially exhibit non-specular phenomena. Indeed, one or more of the diffuse reflectors of the invention can exhibit at least some non-specular character so that at least a portion of the reflected light can spread over a hemispherical projection over the surface.

Some embodiments pertinent to one or more aspects of invention are directed to reflective materials can exhibit a surface luminance phenomena such that at least a portion of light incident thereon is scattered and the intensity of reflected light is the same regardless of the observation perspective. The invention further contemplates embodiments involving diffuse inter-reflection phenomena whereby light reflected from a diffuse surface strikes other surfaces. Further, the various diffuse reflective materials of the invention can have any desirable or advantageous color and reflect light at any acceptable or desired wavelength. Preferably, the reflective material reflects all, or at least a desired wavelength or range of wavelengths.

Any suitable technique can be utilized to enclose, at partially, the scintillation material with the reflective material so as to facilitate preventing scintillation light from leaving the scintillation component except at the one or more optical apertures. For example, the reflective material can comprise a wrapping material, e.g., a tape or sleeve, having the diffuse reflective characteristics. The diffusive reflective tape can be wrapped around the scintillation material. For example, polytetrafluoroethylene (TFE) tape can be used to wrap a plastic scintillator and diffusively reflect scintillation light. Sheets of the reflective material may also be utilized and disposed on the surfaces of the scintillation body to form a case or sheath. Further embodiments of the invention contemplate other techniques that provide a reflective coating on the scintillation body including, for example, spray coating and dip coating techniques. Notably, the diffuse reflector can comprise any material that provides the desired optical characteristics, i.e., diffuse or non-specular reflection, color, density, stability, chemical inertness, mechanical strength, and other desirable properties. Thus, for example, the wrapping material is not limited to the above-mentioned polymeric embodiment.

The reflective material can have any suitable thickness that provides acceptable opacity and diffuse reflective properties. For example, a plurality of layers of TFE tape can be used to wrap a scintillation body, i.e., once, two times, three times, four times, or more, depending the thickness of each wrapping layer.

Further embodiments may involve scintillation components having, on at least a portion of a first surface, a diffise reflective material, and, on at least a portion of a second surface, and/or another portion of the first surface, a specular reflective material. In other embodiments of the invention, the diffuse reflective material comprises pigments that promote non-specular phenomena. Thus, for example, the diffuse reflective coating can comprise titanium dioxide in a binder matrix.

The functions and advantages of these and other embodiments of the invention can be further understood from the examples below. The following examples illustrate the benefits and advantages of the systems and techniques of the invention but do not exemplify the full scope of the invention.

### EXAMPLE 1

This example compares the reflectivity performance of the diffuse reflective material against the reflectivity performance of the specular reflective material.

The reflectivity performance of the TFE and aluminum foil materials was first evaluated. A LAMBDA™ 950 UV-Vis/NIR spectrophotometer, available from PerkinElmer Life and Analytical Sciences, Inc., Wellesley, Mass., fitted with an integrating reflectance assembly from Labsphere, Inc., North Sutton, N.H., was used to determine the percent reflectivity of the reflective materials. The scan parameters were established for the region of interest, between 600 nm-200 nm, a data interval of 1 nm, at scan a speed/integration rate of 324.44 nm/min. A slit width of 2 nm was used.

The TFE material, supplied by Saint-Gobain Performance Plastics Corporation, part number 121025NA12000, was evaluated as single layer, two layers, three layers, and four layers to determine spectrum maximization. The TFE material (or TFE tape) had a thickness of about 0.08 mm.

Two different suppliers of aluminum foil material were evaluated, REYNOLDS WRAP® 624 heavy duty food service foil, from Alcoa, Inc., Pittsburgh, Pa., and Food Services Aluminum foil, product code 286, from Western Plastics, Temecula, Calif.

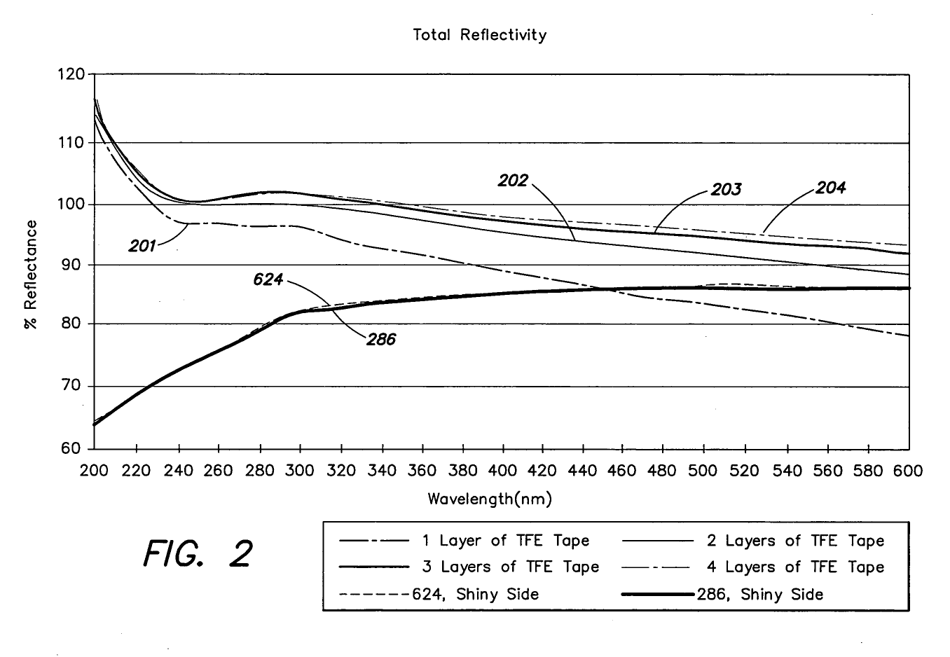

The percent reflectivity curves for the TFE (single 201, two wraps 202, three wraps 203, and four wraps 204), REYNOLDS WRAP® 624, and Western Plastics 286 are shown in FIG. 2. The average percent reflectivity over the wavelength range of 400 nm-460 nm was calculated from the raw data from the TFE (single, two wraps, three wraps, and four wraps), REYNOLDS WRAP® 624, and Western Plastics 286 samples and is presented in Table 1.

TABLE 1
Wavelength Range 400 nm–460 nm

| Sample | Average % Reflectivity |
|---|---|
| TFE, single layer | 87.20 |
| TFE, two layers | 94.09 |
| TFE, three layers | 96.32 |
| TFE, four layers | 97.14 |
| REYNOLDS WRAP ® 624 | 86.17 |
| Western Plastics 286 | 85.83 |

The data shows that the reflectivity efficiency of two, three, and four wraps of TFE tape is higher than that of both aluminum foil materials. The improved reflectivity is expected to improve the overall efficiency of the scintillation component utilizing these diffuse reflective materials.

### EXAMPLE 2

This example compares the performance of a scintillation component utilizing diffuse reflective material against the performance of a scintillation component utilizing conventional, specular reflective material.

Three samples of BC-408 plastic scintillation material (from Saint-Gobain Ceramics & Plastics, Newbury, Ohio), with dimensions of 70×14×2.25 inches were evaluated. The surfaces with dimension of 2.25×70 inches and 2.25×14 inches were diamond milled to provide an optical quality finish. Three samples of BC-412 plastic scintillation material (also from Saint-Gobain Ceramics & Plastics, Newbury, Ohio), with dimensions of 70×14×2.25 inches were also evaluated. The surfaces with dimension of 2.25×70 inches and 2.25×14 inches were similarly diamond milled.

To evaluate the performance of the scintillation materials, each was wrapped with diffusive reflective material, TFE tape as described below, and compared to the performance using conventional, specular reflective material, aluminum foil, as also described below.

Non-specular specimens were prepared by wrapping to provide three layers of TFE tape, Saint-Gobain Performance Plastics Corporation, part no. 121025NA12000, around each of the BC-408 and BC-412 scintillation bodies. A layer of aluminum foil and a layer of 50 mil vinyl tape were placed over the TFE layers. The corners were optically sealed with vinyl adhesive tape.

For each of the BC-408 and BC-412 bodies, four bialkali cathode PMT devices (part no. 6095, from Hamamatsu Photonics K.K.) were optically coupled to the exposed end. To quantify the difference in count efficiency, the following procedure was used.

Before each sample was evaluated, the scintillator/PMT assembly was calibrated using a high energy excitatory radiation source (based on Cesium-137) emitting γ-rays of 662 keV.

Background radiation was quantified by aggregating the counts measured by the four PMT devices for thirty seconds to provide an average background radiation level.

Each of the three BC-408 bodies wrapped in three layers of TFE tape were exposed for thirty seconds to a low energy excitatory radiation source (Americium-241) emitting γ-rays at about 60 keV. The counts per second detected by each of the PMT devices for each diffusive reflector-wrapped bodies were aggregated. An average detected count per time value for the BC-408 bodies was calculated after compensating for background radiation. Each of the three BC-412 bodies wrapped in three layers of TFE were also evaluated by calibrating with the high energy source and exposing with the low energy source as described above.

The above-described procedure was repeated using each of the same BC-408 and BC-412 bodies, except using aluminum foil (product code 286, from Western Plastics) in place of the TFE tape to provide specular reflective material.

The averaged results are summarized in Table 2 and shows the improved count efficiency exhibited by using diffuse reflective materials, compared to specular reflective materials. Surprisingly, an average increase of about 30% was realized by using diffuse reflective materials when detecting and/or monitoring low energy γ-ray radiation, compared to specular reflective materials.

TABLE 2
Improvement of Using Diffuse Reflective Materials (TFE Wrap) Instead of
Specular Reflective Materials (Aluminum Foil)

| | Average, | | |
|---|---|---|---|
| | Aluminum Foil | Average, TFE | Average Increase |
| Type | (counts/sec) | (counts/sec) | (%) |
| BC-408 | 3788.33 | 4951.67 | 30.7 |
| BC-412 | 3662.67 | 4735.00 | 29.3 |

The above-described evaluation procedure was used to evaluate the performance in terms of increased count efficiency by using a diffuse reflective material relative to aluminum foil at high energy γ-ray levels by using Cs-137 instead of Am-241. As presented in Table 3, the difference in measured counts at the high energy levels is about 5%.

This change in performance was significantly less at the high energy conditions. The high energy data (Table 3) shows that substituting a diffuse reflective material for a specular reflective material would produce only a nominal increase in count efficiency. Thus, the increase in count efficiency is surprising and unexpected at the low energy exposure conditions (Table 2). Stated plainly, an order of magnitude difference in efficiency as manifested by increased detected counts by using the diffuse reflective materials of the invention provides unexpected results based on the performance at high energy exposure conditions. This is particularly notable especially because, as noted above, organic scintillators have been conventionally used in high energy γ-ray applications.

TABLE 3
Average Difference Using Foil Instead of TFE Wrap at High Energy
Exposure Levels

| | Average, | | Average |
|---|---|---|---|
| | Aluminum Foil | Average, TFE | Difference |
| Type | (counts/sec) | (counts/sec) | (%) |
| BC-408 | 9797.00 | 10300.50 | 5.1 |
| BC-412 | 10138.00 | 10610.00 | 4.7 |

The term “radiation” refers to electromagnetic radiation or particles. The term “light” refers to electromagnetic radiation of any wavelength and is not limited to light in the visible spectrum. The term “scintillator” refers to a component that utilizes at least one phosphorescent material that emits light in response to excitatory radiation incident thereon.

Several embodiments, one or more of which can be pertinent to one or more aspects of the invention, are exemplarily presented such that one ordinarily skilled in the art can readily appreciate alterations, variations, modifications, and improvements thereto. Such alterations, modifications, and improvements are intended to be part of this disclosure, and are intended to be within the spirit and scope of the invention. For example, one or more PMT detectors can be utilized in the systems and techniques of the present invention and, in accordance with some embodiments. Indeed, one or more scintillation components may be coupled to one or more PMT devices. Further, the scintillation body of the invention is not limited to the above-described shape and can have any suitable or desired shape. Accordingly, the foregoing description and drawings are by way of example only.

What is claimed is:

1. A radiation detection apparatus comprising an organic scintillator and a diffusive reflective material disposed on at least a portion of a surface of the organic scintillator.

2. The apparatus of claim 1, wherein the diffusive reflective material comprises polytetrafluoroethylene.

3. A method of fabricating a radiation detector comprising enclosing at least a portion of an organic scintillator with at least one diffusive reflective material.

4. The method of claim 3, wherein the diffusive reflective material comprises polytetrafluoroethylene.

5. The method of claim 4, further comprising an act of coupling a photodetector assembly to the organic scintillator.

6. A method of characterizing a radiation emission comprising acts of:
providing a radiation detection apparatus comprising an organic scintillator having a diffuse reflective material on at least a portion of at least one surface thereof and at least one photomultiplier assembly operatively coupled to the organic scintillator; and
exposing the radiation detection apparatus to the emission.

7. The method of claim 6, further comprising an act of providing an electronic representation of a magnitude of the radiation emission.
